(19) United States
(12) Patent Application Publication
(10) Pub. No.: US 2017/0199829 A1
(43) Pub. Date: Jul. 13, 2017

(54) Universal Serial Bus Cable With Active Signal Conditioning Circuitry

(71) Applicant: DELPHI TECHNOLOGIES, INC., TROY, MI (US)

(72) Inventors: Richard J. Boyer, Mantua, OH (US); John F. Heffron, Youngstown, OH (US)

(21) Appl. No.: 14/990,237

(22) Filed: Jan. 7, 2016

(51) Int. Cl. G06F 13/10; G06F 13/42; G06F 13/40

(52) U.S. Cl. CPC G06F 13/102; G06F 13/4068; G06F 13/4282

(57) ABSTRACT

A Universal Serial Bus (USB) cable assembly is configured to interconnect a USB device, such as a smartphone or digital music player, disposed within a motor vehicle with a USB hub disposed within the motor vehicle, such as in the vehicle's infotainment system. The USB cable assembly includes a first connector configured to interface with the USB hub, a second connector configured to interface with the USB device, and a plurality of wire cables interconnecting the first connector and the second connector. The USB cable assembly further includes a signal conditioning circuit in communication with the first connector, the second connector and the plurality of wire cables. The signal conditioning circuit is disposed intermediate the first connector and the second connector.

### TECHNICAL FIELD OF THE INVENTION

The invention relates to a Universal Serial Bus cable, particularly a Universal Serial Bus cable having active signal conditioning circuitry.

### BACKGROUND OF THE INVENTION

The use of Universal Serial Bus (USB) ports in today's automobiles and other motor vehicles is extensive. These remote USB ports are placed at various locations within the vehicle allowing a user to connect a USB device, e.g. a memory device (thumb drive) or consumer electronic device (smartphone, tablet computer), to share digital data with a remote USB hub, typically contained in the vehicle's infotainment system. A USB cable extending between a USB user port in the rear portion of the vehicle and the remote USB hub in the vehicle's instrument panel may have a length near or exceeding a 5 meter (m) maximum defined in the USB 2.0 standards. The USB 3.1 Super Speed Gen. 1 [5 Gigabits per second (Gbps)] standard specifies a maximum cable length of 3 meters and the USB 3.1 Super Speed Gen. 2 (10 Gbps) standard specifies a maximum cable length of 1 meter. In addition, a user may use an extension USB cable to connect the USB device with the USB port, further increasing the effective USB cable length. Exceeding this recommended cable length degrades the USB signals and diminishes performance of the USB data link. In automotive applications, a user has no idea how much cabling is used in the vehicle to connect the USB user port to the remote USB hub. Therefore, a user would likely expect that any cable meeting the standard, including a cable up to 5 meters long will work in the automotive application. However, due to the automobile's cabling, this may not be true.

For many applications in today's vehicles the solution has been to use a standalone USB module that houses another USB hub to connected to the remote USB hub in order to interconnect with the user's USB device. However, this solution has several drawbacks including increasing the following; part cost, mass, part count, mounting requirements, design and validation time.

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

### BRIEF SUMMARY OF THE INVENTION

In accordance with an embodiment of the invention, a Universal Serial Bus (USB) cable assembly is provided. The USB cable assembly is configured to interconnect a USB device disposed within a motor vehicle with a USB hub disposed within the motor vehicle. The USB cable assembly includes a first connector configured to interface with the USB hub, a second connector configured to interface with the USB device, a plurality of wire cables interconnecting the first connector and the second connector; and a signal conditioning circuit in communication with the first connector, the second connector and the plurality of wire cables. The signal conditioning circuit is disposed intermediate the first connector and the second connector.

The USB cable assembly may be between 0.5 and 5 meters long. Each wire cable in the plurality of wire cables may be between 0.5 and 5 meters long. The signal conditioning circuit may be integrated with the second connector. The USB cable assembly may further include a housing encapsulating the second connector and the signal conditioning circuit. The USB cable assembly may be disposed within the motor vehicle. The USB cable assembly may be interconnected with an infotainment system. The USB cable assembly may conform to the USB 2.0 and/or USB 3.1 standard.

### BRIEF DESCRIPTION OF THE SEVERAL VIEWS OF THE DRAWING

The present invention will now be described, by way of example with reference to the accompanying drawings, in which:

FIG. 1 is a schematic diagram of a USB hub interconnected to USB port via a USB cable assembly according to one embodiment;

FIG. 2 is a top view of the signal conditioning circuit integrated with the user port of the USB cable assembly according to one embodiment; and

FIG. 3 is a graph of typical voltage and timing of USB signals output by a USB hub with compliance template for this location in data stream;

FIG. 4 is a graph of typical voltage and timing of USB signals received from the USB hub at the end of a 3 to 5 meter USB cable;

FIG. 5 is a graph of typical voltage and timing of USB signals received from the USB hub via an active USB cables having a length of 0.5 to 5 meters according to one embodiment.

### DETAILED DESCRIPTION OF THE INVENTION

A Universal Serial Bus (USB) cable assembly is presented herein that includes active signal condition circuitry that allows reliable data communication between a USB hub and a USB device connected by USB cables having a total overall length exceeding 5 meters. This overall length includes the length of a USB cable from the USB hub to a user port and the length of another USB cable from the user port to the USB device.

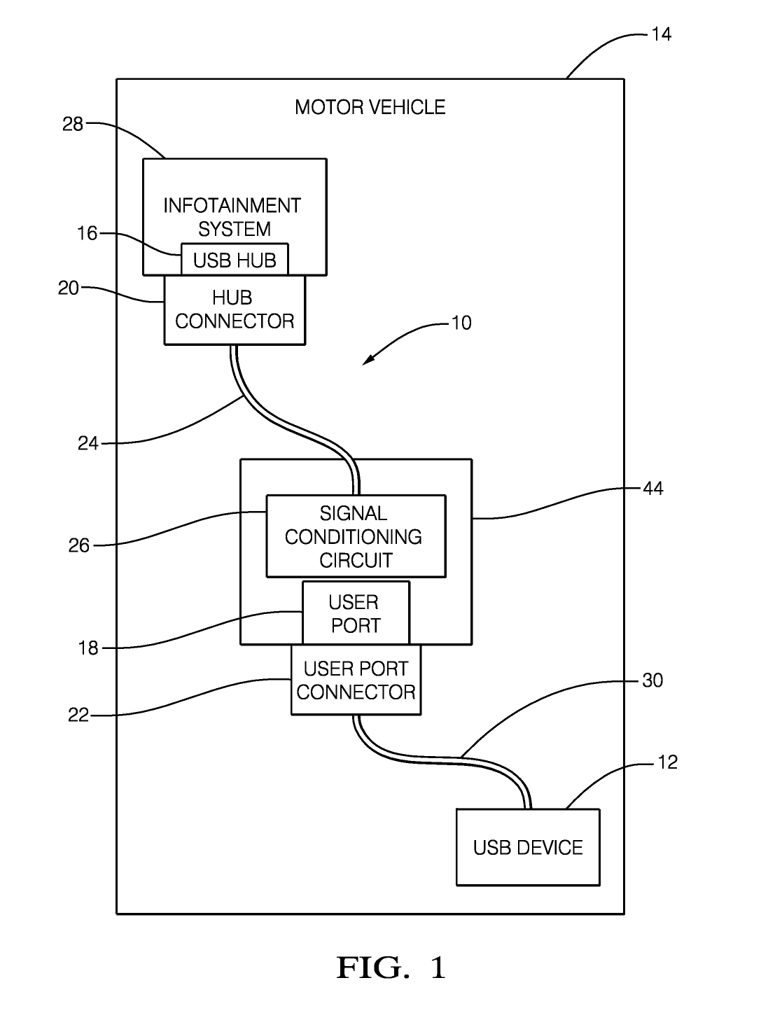

FIG. 1 illustrates a non-limiting example of a USB cable assembly 10, hereinafter referred to as the assembly 10. The assembly 10 shown here is configured to interconnect a USB device 12 within a motor vehicle 14 with a USB hub 16 within the motor vehicle 14 that is remote from a user port 18 to which the USB device 12 is connected. The assembly 10 includes a first connector 20, hereinafter referred to as a hub connector 20, that is configured to interface with the USB hub 16, a second connector 22, hereinafter referred to as a user port connector 22, that is configured to interface with a user port 18, and a plurality of wire cables 24 interconnecting the hub connector 20 and the user port connector 22. The assembly 10 also includes an active signal conditioning circuit 26 in electrical communication with the hub connector 20, the user port connector 22 and the plurality of wire cables 24. The signal conditioning circuit 26 is disposed in the assembly 10 intermediate the hub connector 20 and the user port connector 22.

In an assembly 10 that conforms to the USB 2.0 standard, there are four wires (not shown) in the plurality of wire cables 24: a twisted pair of configured to transmit digital signals (D+, D−), a third wire carrying 5 volt electrical power (V_{cc}) from the USB hub 16 and fourth wire grounded to the USB hub 16 (GND). The assembly 10 may further include a braided or foil ground shield (not shown) surrounding the plurality of wires and a drain wire (not shown) configured to connected the ground shield to electrical ground. In an assembly 10 conforming to the USB 3.1 standard, there are two additional twisted pairs of wires (not shown) in the plurality of wires configured to carry higher speed digital signals. As used herein, the USB 2.0 and 3.1 standards refers to the standards contained in the documents Universal Serial Bus Specification Revision 2.0 published by the USB Implementers Forum on Apr. 27, 2000 and Universal Serial Bus 3.1 Specification Revision 1 published by the USB Implementers Forum on Jul. 26, 2013, both of these documents are hereby incorporated by reference. The USB 3.1 standards incorporate and are backwardly compatible with USB 2.0 and USB 3.0 standards.

As illustrated in FIG. 1, the USB hub 16 is part of a vehicle infotainment system 28 that provides music, video, and/or information programming to the occupants of the vehicle 14. The user port 18 connects a USB device 12 to the USB hub 16 via the assembly 10. The USB device 12 may be a USB enabled consumer electronic device, such as a smartphone, tablet computer, or digital music player. The infotainment system 28 and the USB device 12 exchange digital information via the USB hub 16, assembly 10, and user port 18 to send music, video, and/or information data between the infotainment system 28 and the USB device 12. The USB device 12 may be plugged directly into the user port 18, e.g. a passive USB cable 30 may be used to interconnect the USB device 12 with the user port 18, e.g. a smartphone. As used herein, a passive USB cable does not include any active signal processing circuitry.

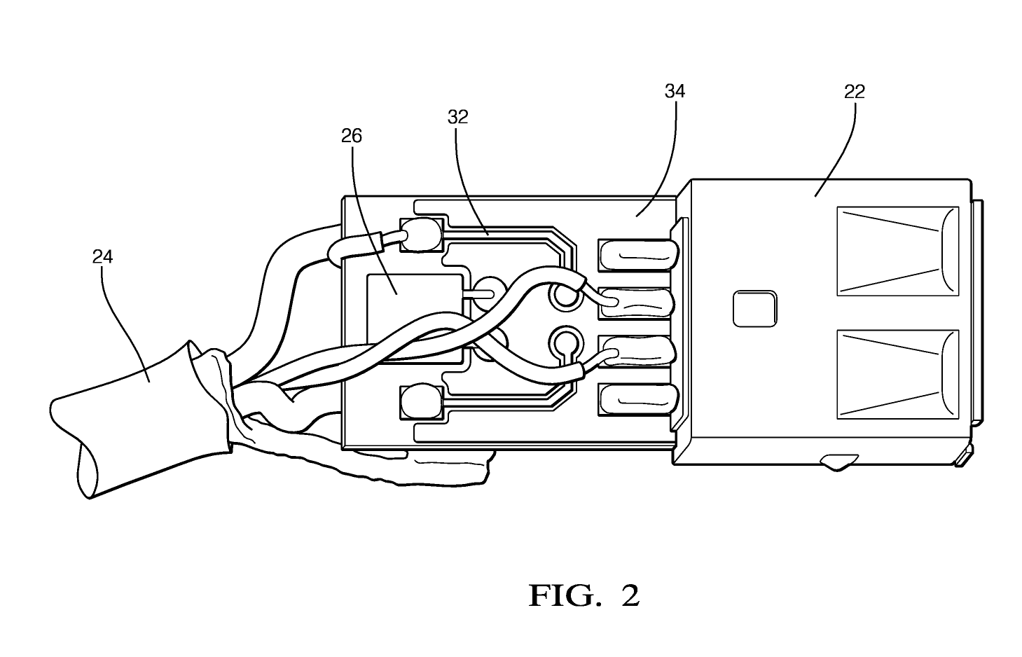

As illustrated in FIG. 2, the signal conditioning circuit 26 is integrated with the user port connector 22. The signal conditioning circuit 26 in this embodiment is an integrated circuit (IC) that is physically and electrically attached to conductive traces 32 on a printed circuit board (PCB) 34. The plurality of wire cables 24 and user port connector 22 are interconnected to the signal conditioning circuit 26 by the conductive traces 32. The signal conditioning circuit 26 is provided electrical power from the USB hub 16 by the third and fourth wires (V_{cc} and GND) of the plurality of wire cables 24. Examples of integrated circuits capable of providing signal conditioning for the USB signals include Model TUSB211 for USB 2.0 applications and Model SN65LVPE512 for USB 3.1 applications, both manufactured by Texas Instruments of Dallas, Tex.

The signal conditioning circuit 26 is designed to restore the USB signals that have been degraded by the cable, this is known as inter symbol interference (ISI). This restoration of the signal is accomplished by amplifying the high frequency content of the signal. This type of amplification of only the lost frequency content is known as equalization. ISI is caused primarily by the capacitive load in the wire cables 24.

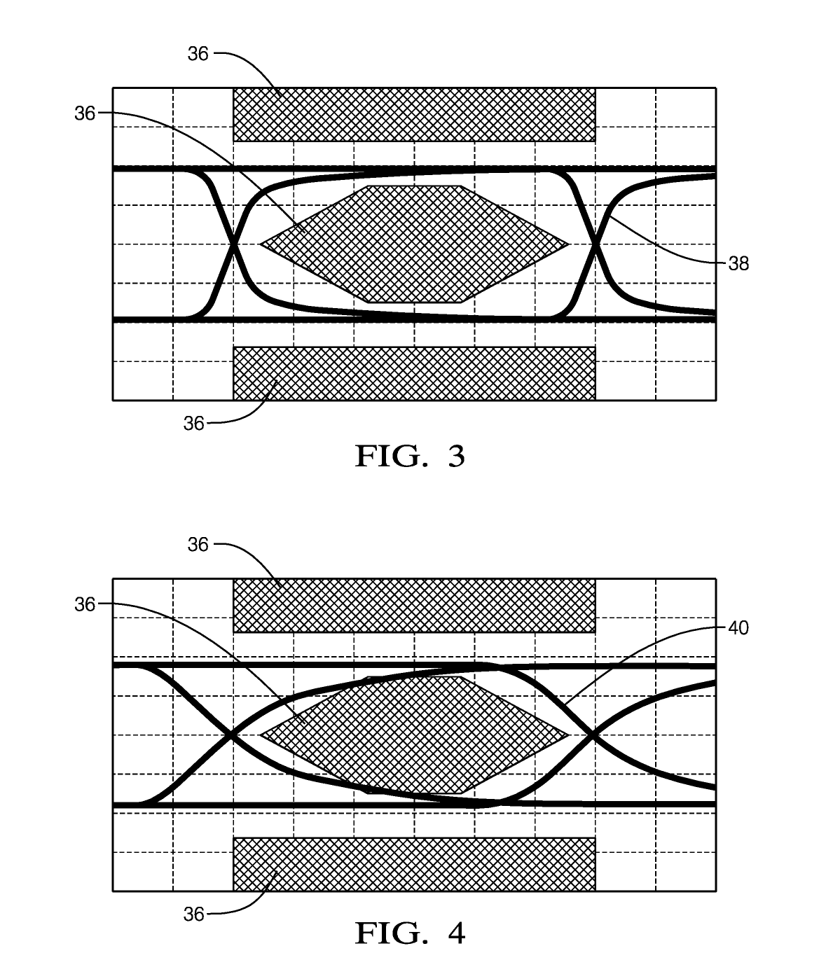

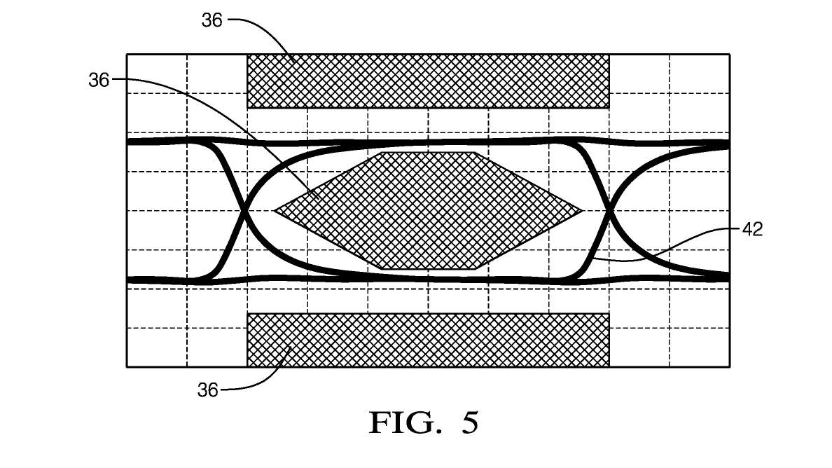

FIGS. 3-5 show graphs containing examples of the voltage and timing of USB signals. The USB data signal voltage level and timing at the USB hub 16 in are shown in FIG. 3. The USB data signal voltage level and timing at the end of the plurality of wire cables, in this example having a length of 1.5 to 5 meters, is shown in FIG. 4. The graphs in FIGS. 3-5 are referred to as “eye charts” due to the eye shaped keep out zone 36 in the middle of each graph. For reliable USB data transmission to occur, the signals must avoid intruding into the keep out zone 36. As shown in FIG. 3, the USB signals 38 originating from the USB hub 16 avoid entering the shaded zone. However, as shown in FIG. 4, some of the USB signals 40 received over the plurality of wire cables 24 at the user port 18 have degraded so that they are now impinging on the shaded zone. FIG. 5 shows the USB data signal voltage level and timing of USB signals 42 as output from the assembly 10 to the user port 18 including the active signal conditioning circuit 26. The USB signals 42 are amplified and equalized by the signal conditioning circuit 26 so that they no longer enter the keep out zone 36.

As shown in FIG. 1, the signal conditioning circuit 26 and the user port connector 22 are contained within a molded housing 44 in order to protect the signal conditioning circuit 26 and the wire cable/user port interfaces. The hub connector 20 may also be contained within another molded housing (not shown).

In motor vehicle 14 applications of the assembly 10, the length of the assembly 10 may be between 0.5 and 5 meters long.

Other embodiments of the assembly may be envisioned wherein the plurality of wire cables does not include a power and ground wire and electrical power may be supplied directly to the USB port from an electrical power supply separate from the USB hub.

Accordingly an assembly 10 is provided that provides the benefits of connecting a USB hub 16 to a USB device 12 having a cable length of more than 5 meters between the USB hub 16 and the device. The signal conditioning circuit within the assembly 10 amplifies and equalizes the USB data signals at the user port 18 connector so that ISI interference is reduced, ensuring a reliable digital communication link between the USB hub 16 and the USB device 12. This allows a passive USB cable 30 of up to 5 meters in length to be used in automotive applications having user ports remote from the USB hub. This assembly 10 further provides the benefit of eliminating the need to add an additional USB hub at the user port. The inventors have also found that this assembly 10 allows for use of a passive USB cable 30 having impedance values near the upper or lower limits of the USB specifications in automotive applications.

While this invention has been described in terms of the preferred embodiments thereof, it is not intended to be so limited, but rather only to the extent set forth in the claims that follow. Moreover, the use of the terms first, second, etc. does not denote any order of importance, but rather the terms first, second, etc. are used to distinguish one element from another. Furthermore, the use of the terms a, an, etc. do not denote a limitation of quantity, but rather denote the presence of at least one of the referenced items.

1. A Universal Serial Bus (USB) cable assembly configured to interconnect a USB device disposed within a motor vehicle to a USB hub disposed within the same motor vehicle, said USB cable assembly comprising:
a first connector configured to interface with the USB hub;
a second connector configured to interface with the USB device;
an active signal conditioning circuit connected to the second connector and integral to the second connector; and
a plurality of wire cables interconnecting the active signal conditioning circuit to the first connector, wherein the signal conditioning circuit is provided electrical power from the USB hub via two of the plurality of wire cables and wherein the USB cable assembly includes no circuitry other than the plurality of wire cables intermediate the active signal conditioning circuit and the first connector.

2. The USB cable assembly according to claim 1, wherein the USB cable assembly is between 0.5 and 5 meters long.

3.-4. (canceled)

5. The USB cable assembly according to claim 1, further comprising a housing encapsulating the second connector and the active signal conditioning circuit.

6. The USB cable assembly according to claim 1, wherein the USB cable assembly is disposed within the motor vehicle.

7. The USB cable assembly according to claim 6, wherein the USB cable assembly is interconnected with an infotainment system.

8. The USB cable assembly according to claim 1, wherein the USB cable assembly conforms to the USB 2.0 standard.

9. The USB cable assembly according to claim 8, wherein the USB cable assembly further conforms to the USB 3.1 standard.

10. The USB cable assembly according to claim 1, wherein the active signal conditioning circuit is configured to amplify only the high frequency content of the signal of a USB signal transmitted between the USB hub and the USB device.

11. (canceled)

12. The USB cable assembly according to claim 10, wherein the active signal conditioning circuit is configured to equalize the high frequency content of the signal of a USB signal transmitted between the USB hub and the USB device.
